(19) United States
(12) Patent Application Publication
(10) Pub. No.: US 2021/0256443 A1
(43) Pub. Date: Aug. 19, 2021

(54) METHODS AND SYSTEMS FOR SUPPLY CHAIN NETWORK OPTIMIZATION

(71) Applicants: SHASHANK SRIVASTAVA, Bangalore (IN); RAHUL JAIN, Gurgaon (IN); GEET GARG, Lucknow (IN); CHAITANYA SANGANI, Kakinada (IN); KEVIN ABRAHAM, Ernakulam (IN)

(72) Inventors: SHASHANK SRIVASTAVA, Bangalore (IN); RAHUL JAIN, Gurgaon (IN); GEET GARG, Lucknow (IN); CHAITANYA SANGANI, Kakinada (IN); KEVIN ABRAHAM, Ernakulam (IN)

(21) Appl. No.: 16/953,308

(22) Filed: Nov. 19, 2020

Related U.S. Application Data
(60) Provisional application No. 62/937,674, filed on Nov. 19, 2019.

(51) Int. Cl. G06Q 10/06

(52) U.S. Cl. CPC G06Q 10/06315; G06Q 10/067

(57) ABSTRACT

A computerized method for implementing an optimal supply chain configuration includes the step of implementing an optimal supply chain configuration for a business. The method includes the step of modelling costs for minimization in an optimal supply chain configuration. The method includes the step of modelling constraints in an optimal supply chain configuration. The method includes the step of, based on the modelled cost for minimization and the modelled constraints, optimizing a supply chain for the business.

### CROSS-REFERENCE TO RELATED APPLICATIONS

This application claims priority to U.S. provisional patent application No. 62/937,674, titled METHODS AND SYSTEMS FOR SUPPLY CHAIN NETWORK OPTIMIZATION and filed on 19 Nov. 2019. This application is hereby incorporated by reference in its entirety.

### BACKGROUND

### 1. Field

This application relates generally to machine learning, and more particularly to a system, method, and article of manufacture for supply chain network optimization.

### 2. Related Art

Supply chain is a system of organizations, people, activities, information, and resources involved in supplying a product or service to a consumer. Increasingly, software solutions are used for determining an optimal supply chain configuration for a business. In order to do, the software solution must be able to solve various questions such as the following. Where should the warehouses be located? Where should the factories be located? How large should the warehouses be? What is the optimal flow mapping of the supply chain? Increasingly, machine learning has be used to solve and automate various business problems as well. Accordingly, improvement to software solutions that optimize supply chains with various machine learning methods are desired.

### SUMMARY OF THE INVENTION

A computerized method for implementing an optimal supply chain configuration includes the step of implementing an optimal supply chain configuration for a business. The method includes the step of modelling costs for minimization in an optimal supply chain configuration. The method includes the step of modelling constraints in an optimal supply chain configuration. The method includes the step of, based on the modelled cost for minimization and the modelled constraints, optimizing a supply chain for the business.

### BRIEF DESCRIPTION OF THE DRAWINGS

FIG. 1 illustrates an example process for implementing an optimal supply chain configuration for a business, according to some embodiments.

FIG. 2 illustrates an example process for modelling costs for minimization, according to some embodiments.

FIG. 3 illustrates an example process for modelling constraints in an optimal supply chain configuration, according to some embodiments.

FIG. 4 illustrates an example process for optimizing, according to some embodiments.

FIG. 5 is a block diagram of a sample computing environment that can be utilized to implement various embodiments.

FIG. 6 illustrate an example process for using mixed integer programming to solve network optimization problems, according to some embodiments.

The Figures described above are a representative set and are not an exhaustive with respect to embodying the invention.

### DESCRIPTION

Disclosed are a system, method, and article of manufacture for supply chain network optimization. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ in an embodiment,′ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Greenfield Analysis can be a built-in any Logistix experiment. Greenfield Analysis can enable the placement of warehouses and production facilities depending on customer demand and locations.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Mixed integer linear programming (MILP) involves problems in which only some of the variables are constrained to be integers, while other variables are allowed to be non-integers.

Minimum Order Quantity (MOQ) can be used in trade to determine a product's minimum number of pieces to place an order.

A service-level agreement (SLA) is a contract between a service provider and its customers that defines the service standards the provider is obligated to meet. In the model's context the service standards translate to the distance/time in which a customer needs to be serviced.

Example Methods and Systems

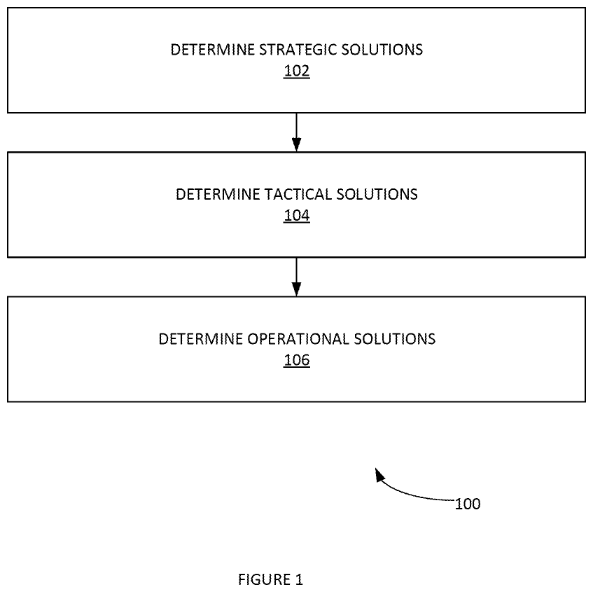

FIG. 1 illustrates an example process 100 for implementing an optimal supply chain configuration for a business, according to some embodiments. Process 100 can be used to implement network optimization as a software solution for determining the optimal supply chain configuration for a business. In step 102, process 100 can determine strategic solutions. Strategic solutions can include determine the location of, inter alia: warehouses, factories, size of warehouses, etc. Process 100 can determine an optimal flow mapping of the entity's supply chain.

In step 104, process 100 can determine tactical solutions. Tactical solutions can include, inter alia: origin of procured material; optimal safety stock values to be held at the DCs to account for demand variability under lead time; location of the stock be held to account for risk pooling; the optimal fleet at all the supply chain nodes; factory capacity planning; identity modes of transportation to be used; types of transportation contracts to be obtained with transportation providers; etc.

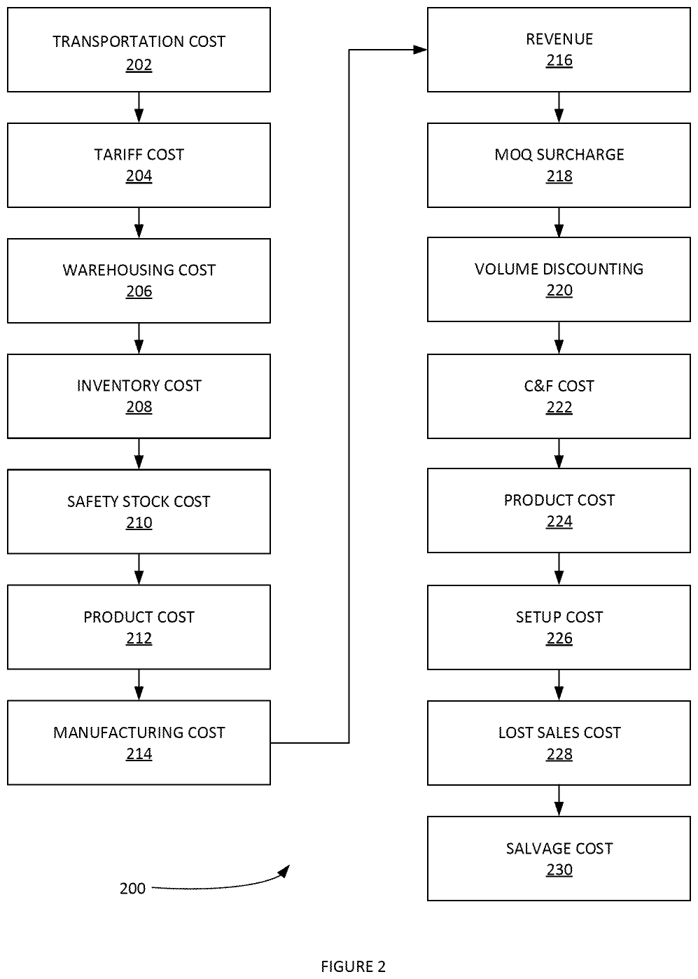

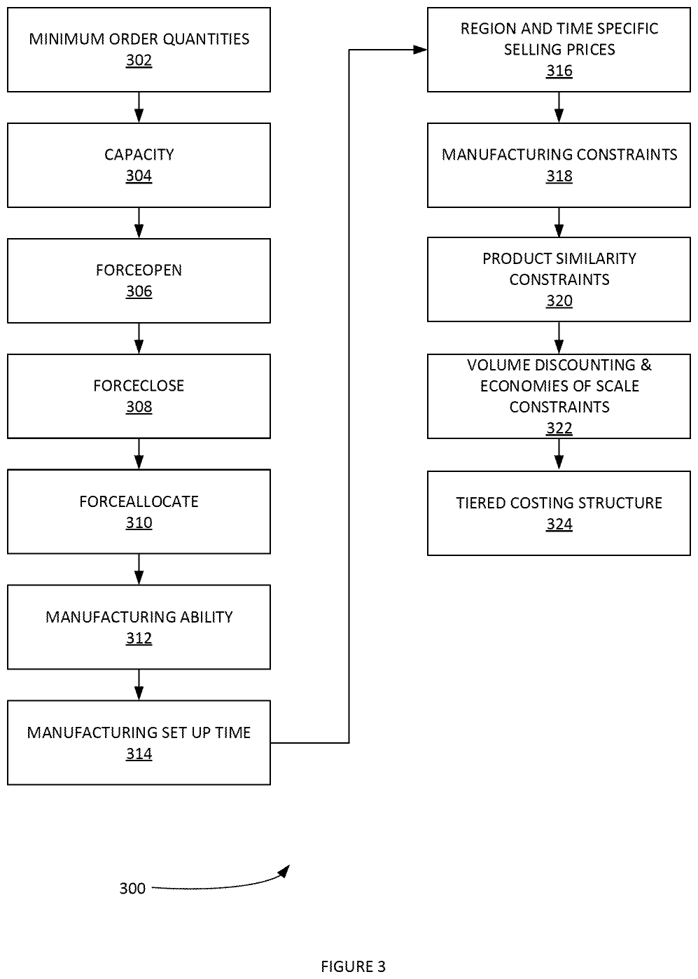

In step 106, process 100 can determine operation solutions. Operational solutions can include, inter alia: determining which customers to be serviced if there are constraints; products are to be sold; identity of constraints; identification of last mile customer clusters for demand fulfillment via milk runs; where mobile cross docks are to be placed; etc. Process 100 can be implemented such that the costs provided in FIG. 2 while respecting the constraints of FIG. 3 are minimized.

FIG. 2 illustrates an example process 200 for modelling costs for minimization in an optimal supply chain configuration, according to some embodiments. Process 200 can model the following costs for minimizations. In step 202, process 200 can model transportation costs. Parameters to include in developing a transportation cost model can include, inter alia: per unit cost on an origin destination pair; per km per kg cost; origin-destination pair (e.g. per unit); cost of a shipping lane, multiplied by #units; fixed costs (e.g. represents container cost. If the origin destination cost is available, container cost is calculated by calculating number of containers by dividing: c.f. (#units*unit_weight*eff)/Container_capacity. The origin destination pair costs can also handle a costing structure involving weight or volume moved between the Origin Destination pairs.

In step 204, process 200 can model duty and tariff costs. For origin-destination countries and product category, there can be a separate duty and tariff percentage. This percentage is multiplied to shipping value.

In step 206, process 200 can model warehousing costs. This can be a per unit cost (e.g. a handling cost). A warehouse cost model can include a square foot cost (e.g. SQFT cost). This can be a square footage needed for a throughput is estimated. The SQFT cost can be calculated by multiplying with per_sqft_cost. The warehouse model can include a fixed cost. This can be a fixed setup cost of a warehouse.

In step 208, process 200 process 100 can model an inventory cost. The inventory cost model can include a holding cost. The following equation can be used to calculate a holding cost: #units*ProductValue*InterestRate*Duration. The inventory cost model can include an in transit holding cost. The following equation can be used to calculate an in transit holding cost: #units*ProductValue*InterestRate*TransitDuration.

In step 210, process 200 can model safety stock costs. This safety stock costs model can include stock levels of each product at each supply chain warehousing node.

In step 212, process 200 can model product costs. The product costs model can include cost of procuring a product from a source.

In step 214, process 200 can model manufacturing costs. The manufacturing costs model can include a cost to manufacture a product at a factory.

In step 216, process 200 can model revenue costs. The model revenue model can include a profit made from sales.

In step 218, process 200 can model MOQ surcharge. The MOQ surcharge can include a penalty paid for breach per unit.

In step 220, process 200 can model transportation costs model duty and tariff costs model warehousing costs model an inventory cost model safety stock costs model product costs model manufacturing costs model revenue costs model MOQ surcharge model volume discounting costs. The volume discounting costs can include a discount offered on the order.

In step 222, process 200 can model cost and freight (C&F) costs. The C&F costs model can include a commission paid to an agent as a percentage of sale value.

In step 224, process 200 can model setup costs. The setup costs model can include the cost to setup manufacturing at a factory location.

In step 226, process 100 can model lost sales costs. The lost sales costs model can include a cost of missed opportunity.

In step 228, process 100 can model salvage costs. The salvage costs model can include a cost for perishable or obsolete products.

FIG. 3 illustrates an example process 300 for modelling constraints in an optimal supply chain configuration, according to some embodiments. In step 302, process 300 can model a minimum order quantities. The minimum order quantities model can include a minimum number of units that need to be sourced and/or manufactured. The minimum order quantities model can be applied at the following model variables/parameters, inter alia: factory product; factory cluster-product; factory cluster-product cluster; factory cluster-product cluster time duration; factory cluster-product cluster-production season 326.

In step 304, process 300 can model a capacity constraint. Maximum production that is possible at a location. In case of limited production capacity available, model has the ability to prebuild inventory from earlier time periods. In step 306, process 300 can model a ForceOpen constraint. The ForceOpen constraint model can include a node must be active. In step 308, process 300 can model a ForceClose constraint. The ForceClose constraint model can include a node must remain forced closed. In step 310, process 300 can model a ForceAllocate constraint. The ForceAllocate constraint model can include a force full fill all demand. In step 312, process 300 can model a manufacturing ability constraint. The manufacturing ability constraint model can include the ability of a node in the supply chain to manufacture a product. The minimum order quantities model can be applied at the following model variables/parameters, inter alia: factory product; factory cluster-product; factory cluster-product cluster; factory cluster-product cluster time duration; factory cluster-product cluster-production season 326.

In step 314, process 300 can model a manufacturing setup time constraint. The manufacturing setup time constraint model can include the time needed for a factory to setup a new product. In step 316, process 300 can model a region and time specific selling prices. The region and time specific selling prices constraints model can include selling prices of products can change for each region and each time duration separately.

In step 318, process 300 can model manufacturing constraints. The manufacturing constraints model can include the bill of material constraints for a manufacturing facility. In step 320, process 300 can model a product similarity constraints. The product similarity constraints model can include products that are similar and can be manufactured at a facility at the same machine.

In step 322, process 300 can modelling constraints in an optimal supply chain configuration, according to some embodiments. In step 302, process 300 can model a minimum order quantities model a capacity constraint model a ForceOpen constraint model a ForceClose constraint model a manufacturing setup time constraint model a region and time specific selling prices model manufacturing constraints model a product similarity constraints model a volume discounting and economies of scale constraints. The volume discounting and economies of scale constraints model can include constraints to incentivize mass production of goods. In step 324, process 300 can model a tiered costing structure. The tiered costing structure model can include manufacturing price variability as per changing demand values. In step 326, process 300 can model seasonal constraints. These can be implemented after manufacturing constraints are determined as well in some examples.

In step 328, process 300 can model customer SLA constraints. The service level agreements to be honored for a customer. The customer SLA constraints can be applied at the following model parameters, inter alia: customer-warehouse distance; customer-warehouse travel duration.

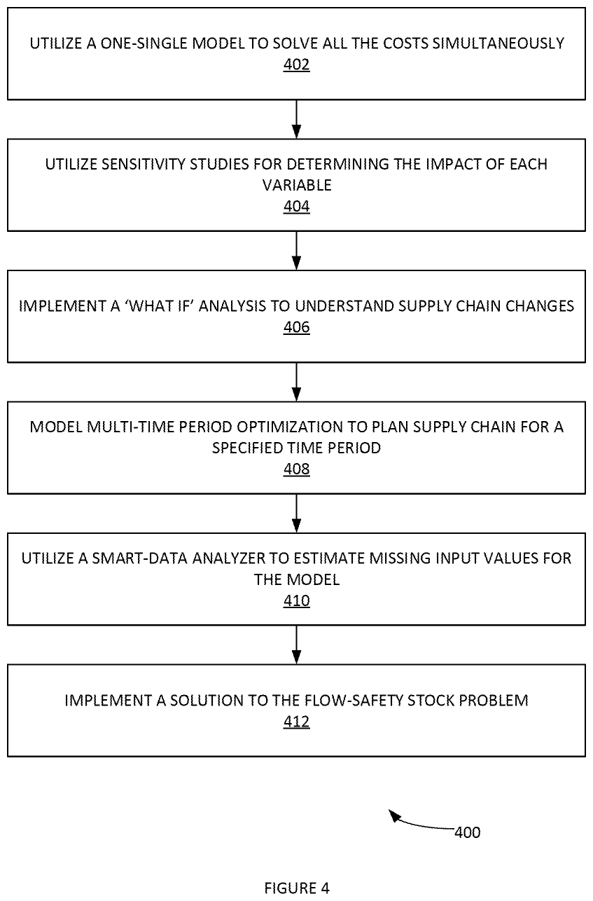

FIG. 4 illustrates an example process 400 for optimizing a supply chain, according to some embodiments. In step 402, process 400 can utilize a one-single model paradigm to solve all the costs simultaneously. In step 404, process 400 can utilize sensitivity studies for determining the impact of each variable. In step 406, process 400 can implement a ‘what if’ analysis to understand supply chain changes. In step 408, process 400 can model multi-time period optimization to plan supply chain for a specified time period (e.g. the next 5-10 years, etc.).

In step 410, process 400 can utilize a smart-data analyzer to estimate missing input values for the model. A transportation matrix can be utilized but may be incomplete. Accordingly, a machine learning model based on random forests can be utilized to estimate the prices for the unknown lanes in the supply chain. The model multi-time period optimization to plan supply chain for a specified time period smartly removes pieces of datasets that are inconsistent to run a minimum feasible mode.

In step 412, process 400 can implement a solution to the Flow-Safety stock problem. This is formulated in such a way, that the model is broken down into a two-stage simultaneous model, and sequential safety stock model, such that decoupled inventory systems are separated.

Additional Example Computer Architecture and Systems

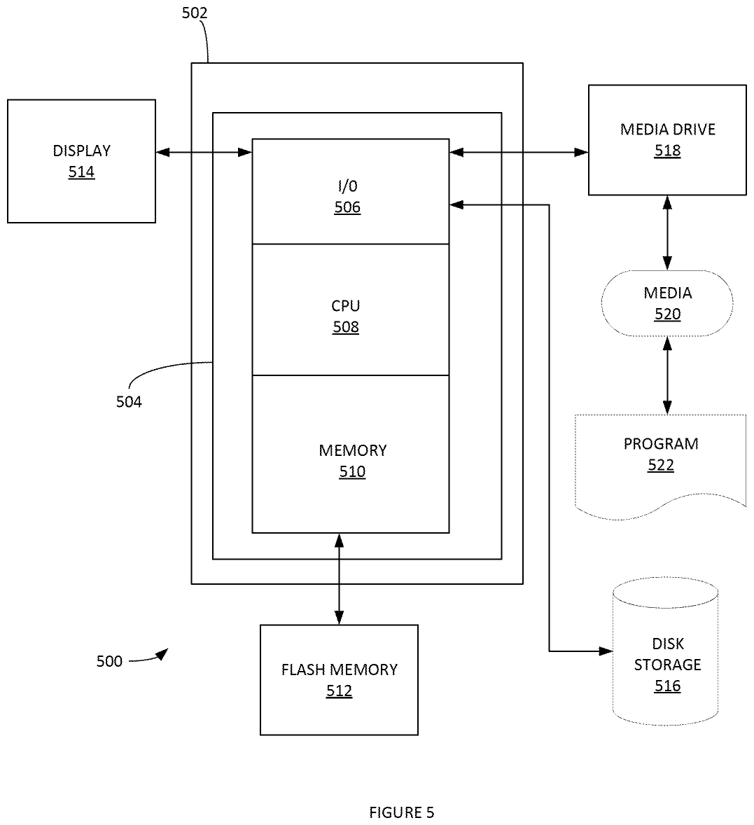

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Additional Processes and Screenshots

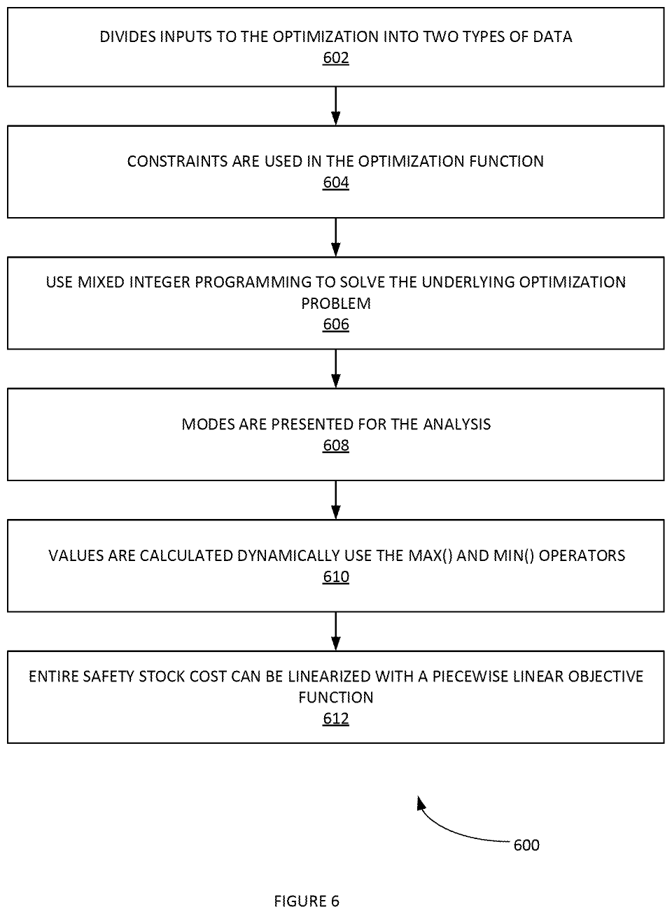

FIG. 6 illustrate an example process 600 for using mixed integer programming to solve network optimization problems, according to some embodiments. In step 602, process 600 divides inputs to the optimization into two types of data. Static data is information which explains the overall structure of the supply chain. For example, static data can include, inter alia, the number of: number of warehouses, sources, factories, customers, cross-docks, ports, shipping modes of transportation available or being evaluated, etc. This includes information, such as: coordinates, maximum capacities, product capabilities, vehicles available, regional accessibility of the region.

Dynamic data inputs are used to explain the dynamics of the optimization. Dynamic data inputs includes, inter alia: manufacturing costs, throughputs of modes, demand of customers, variation of product selling price with respect to time, markdown costs of products and procurement costs of products, etc.

With the information provided, and specific business constraints, the mixed integer program is formulated and solved (e.g. using a MILP/MIQP solver, etc.). Example decision variables used in the optimization can include a flow decision variable. The flow decision variable corresponds to a floating-point number corresponding to a product, time, source, destination and/or a mode of transportation. The flow decision variable can be bound between zero and maximum throughput of the mode for that product at that time.

A production decision variable can correspond to the quantity of product produced at a time at a factory. A setter can be utilized. This can be a binary decision variable. The binary decision variable can correspond to the decision of setting a product at a factory or not. A set variable can be an expression derived from the setter and setting time (e.g. which corresponds to 1 if the product has been set at a location).

A demand satisfied variable can be provided. This can correspond to the demand that is to be satisfied. It can be bound between 0 and maximum demand of a customer. Auxiliary decision variables can be provided. These can correspond to binary decisions that check if a facility is on or not, a flow is on or not, production or sourcing is greater than a threshold or not. These variables are used for implementation of fixed costs and also setting on/off constraints.

In step 604, constraints can be used in the optimization function. Constraints can be divided in two parts. The business constraints are applied to ensure that the optimization generates meaningful solutions. Specific brownfield constraints can then be applied to fine tune the problem for the specific business problem in hand. Relevant business constraints can include, inter alia. Flow balancing constraints can be applied at each node of the supply chain, current inventory is equal to sum of inflow, previous time period's inventory, and the negative of sum of outflows. This value can be set always be greater than zero. Demand satisfying constraints can be applied at the customer node such that inflow needs to be less than equal to the demand at the customer. Zero inventory nodes constraints can be applied at the zero inventory nodes, sum of inflow, must be equal to sum of outflows for each time period. Production balance constraints can be applied for production at a facility in a time period. These can be greater than product shipped out. Production BOM balance constraints can be applied for production of a product. These can be carried out if enough raw materials are available for its production. Production setters constraints can be applied such that production can only take place if the factory has the product set decision variable on at the location.

In step 606, a process 600 provides a combined safety stock model with flow optimization. For the simultaneous solution of the safety stock model with flow optimizations, our approach uses a smart way to decouple flow and safety stock optimization. Every purely diverging system is decoupled from the supply chain optimization and solved sequentially post the optimization. Extra binary variables are created to check if a flow is active during the course of the optimization. If the flow is active, it can be used in the safety stock equation to dynamically update the demand variability and lead time associated with the flow.

In step 608, two modes are presented for the analysis. The pessimistic mode uses the maximum upstream lead time to the node. The optimistic mode uses the minimum upstream lead time in the calculation. In step 610, the values are calculated dynamically use the max( ) and min( ) operators. In step 612, the entire safety stock cost can be linearized with a piecewise linear objective function.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for implementing an optimal supply chain configuration comprising:
implementing an optimal supply chain configuration for a business;
modelling costs for minimization in an optimal supply chain configuration;
modelling constraints in an optimal supply chain configuration;
based on the modelled cost for minimization and the modelled constraints, optimizing a supply chain for the business.

2. The computerized method of claim 1, wherein the step of implementing an optimal supply chain configuration for a business further comprises:
determining a set of strategic solutions for the business;
determining a set of tactical solutions for the business;
determining at least one operation solution for the business.

3. The computerized method of claim 1, wherein the step of modelling costs for minimization in an optimal supply chain configuration further comprises:
model a set of transportation costs; and
model a set of duty and tariff costs.

4. The computerized method of claim 1, wherein the step of modelling costs for minimization in an optimal supply chain configuration further comprises:
modelling a set of warehousing costs;
modelling an inventory cost;
modelling a set of safety stock costs; and
modelling a set of product costs model.

5. The computerized method of claim 4, wherein the step of modelling costs for minimization in an optimal supply chain configuration further comprises:
modelling a set of manufacturing costs;
modelling a set of revenue costs m
modelling a set of volume discounting costs;
modelling a set of cost and freight (C&F) costs;
modelling a set of setup costs;
modelling a set of lost sales costs; and
modelling a set of salvage costs.

6. The computerized method of claim 5, wherein the step of modelling constraints in an optimal supply chain configuration further comprises:
modelling a minimum order quantities model;
modelling a capacity constraint; and
modelling ForceOpen constraint.

7. The computerized method of claim 6 further comprising:
modelling a ForceClose constraint;
modelling a manufacturing setup time constraint; and
modelling a set of a region and time specific selling prices.

8. The computerized method of claim 7 further comprising:
modelling a set of manufacturing constraints;
modelling a set of product similarity constraints; and
modelling a set of volume discounting and economies of scale constraints.

9. The computerized method of claim 8 further comprising:
modelling a tiered costing structure;
modelling a set of seasonal constraints; and
modelling a set of customer SLA constraints.

10. The computerized method of claim 9 further comprising:
optimizing a supply chain by utilizing a one-single model paradigm to solve all the costs simultaneously.

11. The computerized method of claim 10 further comprising:
utilizing a set of sensitivity studies for determining the impact of each variable; and
implementing a ‘what if’ analysis to understand supply chain changes.

12. The computerized method of claim 11 further comprising:
Modelling a mufti-time period optimization to plan supply chain for a specified.

13. The computerized method of claim 12 further comprising:
utilizing a smart-data analyzer to estimate missing input values for the model.
